(19) United States
(12) Patent Application Publication
(10) Pub. No.: US 2026/0077328 A1
(43) Pub. Date: Mar. 19, 2026

(54) MIXED REACTOR AND METHOD FOR PREPARING ELECTROTHERMAL FILM PRECURSOR SOLUTION BASED ON MIXED REACTOR

(71) Applicant: FUJIAN AODUN TECHNOLOGY CO., LTD., Longyan City (CN)

(72) Inventors: HAOQING LUO, Quanzhou City (CN); YUCHUN LI, Quanzhou City (CN)

(73) Assignee: FUJIAN AODUN TECHNOLOGY CO., LTD., Longyan City (CN)

(21) Appl. No.: 19/396,326

(22) Filed: Nov. 20, 2025

Related U.S. Application Data
(63) Continuation of application No. PCT/CN2024/071293, filed on Jan. 9, 2024.

(30) Foreign Application Priority Data
Dec. 29, 2023 (CN) 202311852059.9

(51) Int. Cl. B01J 8/10; B01D 5/00; B01F 23/50; B01F 23/53; B01F 23/80; B01F 27/07; B01F 27/072; B01F 27/112; B01F 27/906; B01F 31/44; B01F 31/80; B01F 35/30; B01F 35/32; B01F 35/45; B01F 35/71; B01F 35/75; B01F 35/90; B01F 35/92; B01F 101/00; B01J 8/08; B01J 8/16; B82Y 30/00; B82Y 40/00; C09D 1/00; C09D 5/24; C09D 7/62; C09D 7/80; F28F 21/08

(52) U.S. Cl. CPC B01J 8/10; B01D 5/0006; B01D 5/0063; B01F 23/511; B01F 23/53; B01F 23/551; B01F 23/56; B01F 23/804; B01F 27/071; B01F 27/0722; B01F 27/0724; B01F 27/112; B01F 27/906; B01F 31/443; B01F 31/449; B01F 31/83; B01F 35/3204; B01F 35/3214; B01F 35/323; B01F 35/45; B01F 35/712; B01F 35/7547; B01F 35/92; B01J 8/085; B01J 8/16; C09D 1/00; C09D 5/24; C09D 7/62; C09D 7/80; F28F 21/089; B01F 2035/351; B01F 2035/98; B01F 2035/99; B01F 2101/2204; B01F 2215/0431; B01F 2215/0472; B01F 2215/0477; B01J 2208/00203; B01J 2208/00212; B01J 2208/00867; B01J 2208/00893; B82Y 30/00; B82Y 40/00

(57) ABSTRACT

Disclosed is a mixed reactor and a method for preparing electrothermal film precursor solution based on the mixed reactor. The mixed reactor includes a reaction kettle body, a reflux condensation mechanism, and a multifunctional stirring mechanism. The reflux condensation mechanism includes a condensate tank, a condensing coil is wound around inside of the condensate tank, two ends of the condensing coil are horizontally arranged, and hermetically and rotatably installed on both sides of the condensate tank, the condensing coil is driven by a coil driving motor; the multifunctional stirring mechanism includes a stirring shaft and a plurality of stirring blades driven by the stirring shaft. The bottom of the stirring shaft is fixedly sleeved with an isolation sleeve. Buffer rubber gaskets are hermetically connected between the mounting parts and the installation holes. It can effectively improve the quality of products and the quality controllability during the product preparation process.

### CROSS-REFERENCE

This application is a continuation of International Application No. PCT/CN2024/071293 with a filling date of Jan. 9, 2024, designating the United States, now pending, which further claims to the benefit of priority from Chinese Application No. 202311852059.9 with a filing date of Dec. 29, 2023. The content of the aforementioned applications, including any intervening amendments thereto, are incorporated herein by reference.

### TECHNICAL FIELD

The present disclosure relates to the technical field of electrothermal film material manufacture, in particular to a mixed reactor and a method for preparing electrothermal film precursor solution based on the mixed reactor.

### BACKGROUND

Electrothermal film is a thin film material that converts electrical energy into thermal energy, which can be used as heating elements for mechanical equipment such as household appliances, agricultural equipment, industrial equipment, and military equipment. Compared with traditional heating elements such as resistance wires and electric thermocouples, the electrothermal film has the advantages of high electric thermal conversion efficiency, long service life, and uniform heating.

The existing preparation process of the electrothermal film precursor solution is generally based on conventional heated reaction kettle for processing. Due to the electrothermal film precursor solution contains many liquid raw materials, and many raw materials need to be mixed and stirred at 70-80° C. in the preparation process, the liquid materials in the raw materials are often in evaporation state. As the processing progresses, the concentration of the electrothermal film precursor solution will increase, which significantly affects product quality and leads to relatively low quality controllability in the preparation process of the electrothermal film precursor solution, which is very troublesome.

To ensure the actual performance of the electrothermal film precursor solution, ultrasonic dispersion of the mixed material is often required during the preparation process of the electrothermal film precursor solution. The existing conventional heated reaction kettle does not have ultrasonic dispersion function. The current approach is to directly install the ultrasonic transducer on the reaction kettle body, but the position of the ultrasonic transducer is fixed, resulting in relatively poor ultrasonic dispersion effect on the material.

Therefore, the objective of the present disclosure is to design a mixed reactor and a method for preparing electrothermal film precursor solution based on the mixed reactor, which can effectively condense and reflux evaporated materials quickly, thus improving the quality of products and the quality controllability in the product preparation process, and can effectively improve the ultrasonic dispersion effect on the mixed materials, thereby further improving the quality of products.

### SUMMARY

In response to the technical problems existing in the above-mentioned prior art, the present disclosure provides a mixed reactor and a method for preparing electrothermal film precursor solution based on the mixed reactor. The mixed reactor and a method for preparing electrothermal film precursor solution based on the mixed reactor can effectively solve the technical problems existing in the above-mentioned prior art.

The technical solution of the present disclosure is:

A mixed reactor includes a reaction kettle body, a reflux condensation mechanism, and a multifunctional stirring mechanism.

A top of the reaction kettle body is hermetically and fixedly connected to a corresponding cover, one side of the cover is provided with a feeding port, a corresponding cover plate capable of opening and closing is arranged at the feeding port, a discharge pipe provided with a discharge valve is arranged on a bottom side of the reaction kettle body;

The reflux condensation mechanism includes a condensate tank located on the side of the cover without the feeding port, a corresponding condensing coil is wound around inside of the condensate tank, two ends of the condensing coil are horizontally arranged, and hermetically and rotatably installed on both sides of the condensate tank, the two ends of the condensing coil are respectively connected to a condensate inlet pipe and a condensate outlet pipe through corresponding rotary joints, one end of the condensate tank is fixedly provided with a coil driving motor for driving the condensing coil to rotate, the cover is provided with an intake pipe for sending evaporated gas into the condensate tank, and a reflux pipe for refluxing the condensed liquid into the reaction kettle body;

The multifunctional stirring mechanism includes a stirring shaft rotatably installed in a middle of the cover, and a plurality of stirring blades driven by the stirring shaft. A bottom of the stirring shaft extends to an inner bottom side of the reaction kettle body and is fixedly sleeved with a corresponding isolation sleeve, the isolation sleeve is provided with a plurality of installation holes corresponding to the stirring blades at equal angles, the stirring blades include a stirring part arranged in a plate shape, and mounting parts arranged in a shaft shape and fixedly connected to an inside of the stirring part, the mounting parts penetrate the installation holes of the isolation sleeve and are fixedly connected to the stirring shaft, the mounting parts of the stirring blades are arranged apart from the installation holes, corresponding buffer rubber gaskets are hermetically connected between the mounting parts of the stirring blades and the installation holes respectively. The stirring shaft on the upper side of the stirring blades is hollow and is provided with a corresponding blind hole, an ultrasonic transducer arranged apart from the blind hole is movably arranged in the blind hole, the ultrasonic transducer is connected to a piston rod end of a driving cylinder fixedly installed on the cover through a corresponding connecting rod, and the ultrasonic transducer is electrically connected to the external ultrasonic generator. When the materials are dispersed, the external ultrasonic generator is started, and the ultrasonic transducer is driven by the driving cylinder to descend and abut against the stirring shaft. The stirring shaft is driven by a stirring driving motor fixedly installed on the cover.

A corresponding heating jacket is hermetically arranged on an outer side of the reaction kettle body in an interlayer manner, a lower part of the heating jacket is externally connected to a heating liquid inlet pipe, and an upper end of the heating jacket is externally connected to a heating liquid outlet pipe.

The two ends of the condensing coil are horizontally arranged, and hermetically and rotatably installed on both sides of the condensate tank through corresponding sealing bearings, one end of the condensing coil is connected to an output shaft end of the coil driving motor through gear engagement in a transmission manner.

The buffer rubber gaskets are hermetically connected to the mounting parts of the stirring blades and the installation holes of the isolation sleeve through adhesive bonding.

A top of the stirring shaft is connected to an output shaft end of the stirring driving motor through gear engagement in a transmission manner.

The middle of the cover is fixedly connected to a corresponding bracket upwards, and a cylinder body of the driving cylinder is fixedly connected to the bracket.

The connecting rod is of a hollow tubular structure, a bottom end of the connecting rod is fixedly connected to a corresponding vibration isolation mechanism downwards, the ultrasonic transducer is fixedly connected to the vibration isolation mechanism.

The vibration isolation mechanism includes a vibration damping container fixed to the bottom end of the connecting rod, the vibration damping container is filled with a plurality of corresponding damping particles for vibration damping, and the damping particles for vibration damping are iron-based spherical particles.

A corresponding conduit longitudinally penetrates between upper end and lower end of the vibration damping container, a threading hole connected to a hollow part of the connecting rod is arranged on an upper side of the connecting rod, the conducting wire of the ultrasonic transducer for connecting passes through the conduit, the hollow part of the connecting rod, and the threading hole, and is then connected to the external ultrasonic generator.

A method for preparing electrothermal film precursor solution based on the mixed reactor, including the following steps:
S1, Adding a tin-containing solution into the reaction kettle body, adding a doped solution and a modifier to the tin-containing solution, adding methanol and isopropanol as cosolvents, and stirring and mixing materials for 38 minutes at 70-80° C. with the multifunctional stirring mechanism to obtain a doped tin-containing solution;
During heating and stirring process, the evaporated gas enters the condensate tank through the intake pipe and flows back into the reaction kettle body after condensing into a liquid;
The doped solution is formed by uniformly mixing antimony trichloride, bismuth chloride, and anhydrous ethanol; the modifier is formed by nickel chloride hexahydrate, manganese chloride tetrahydrate, ferric chloride hexahydrate, cuprous chloride, zinc acetate, and anhydrous ethanol; the tin-containing solution is formed by mixing stannic chloride pentahydrate powder with anhydrous ethanol;
S2, After the multifunctional stirring mechanism is stopped, adding a stabilizer to the doped tin-containing solution, heating for 120 minutes at 65-75° C., the piston rod of the driving cylinder extends to drive the ultrasonic transducer to abut against a bottom side of the blind hole of the stirring shaft, and start the external ultrasonic generator and the multifunctional stirring mechanism, the ultrasonic vibration formed by the ultrasonic transducer is transmitted to the stirring blades during a rotation process through the stirring shaft, and uniformly acts on materials to ultrasonically disperse for 15 minutes;
The stabilizer is formed by uniformly mixing modified carbon nanotubes, 40% silica sol, citric acid, hydrochloric acid, acetic acid and anhydrous ethanol, the diameter of the modified carbon nanotubes is 10-30 nm, the carbon nanotube modification is prepared by mixed acid ultrasonic hot leaching, deionized water rinsing, and vacuum drying, the diameter of the solute particles in the 40% silica sol is 20-25 nm;
S3, Stopping the multifunctional stirring mechanism, and thermal aging the materials at 30° C. for 24-36 hours to obtain the electrothermal film precursor solution;
S4, Draining the electrothermal film precursor solution into corresponding storage tank for storage.

The advantageous effects of the present disclosure are as following:
1) The condensing coil of the reflux condensation mechanism of the present disclosure is arranged inside the condensate tank in a sealed rotating manner, and then driven by a coil driving motor to rotate the condensing coil, thereby greatly improving the contact rate between the condensing coil and the circulating gas. During the product preparation process, the evaporated material enters the condensate tank through the intake pipe and forms efficient contact with the rotating condensing coil to quickly condense and adhere to the outer wall of the condensing coil, thereby significantly improving the condensation efficiency of the evaporated material; and the condensing coil in the rotating state can quickly and efficiently shake off the liquid material attached to the outer wall of the condensing coil, allowing the liquid material to quickly reflux back into the reaction kettle body to participate in the mixing reaction, thereby improving the quality of the product and the quality controllability of the product preparation process.
2) When the multifunctional stirring mechanism of the present disclosure is used for conventional stirring, the stirring blades are driven by the stirring shaft to normally stir materials, at this moment, the ultrasonic transducer is not started and does not contact with the stirring shaft; when the material needs to be dispersed, the external ultrasonic generator is started, and the ultrasonic transducer is driven by the driving cylinder to descend and abut with the stirring shaft, so as to transfer the ultrasonic vibration generated by the ultrasonic transducer to the stirring blades in the rotating process through the stirring shaft, and then uniformly acts on the material to achieve ultrasonic dispersion. Thus, it can effectively improve the ultrasonic dispersion effect of the mixed material to further enhance the quality of the product, and ensure that the ultrasonic transducer does not come into contact with the stirring shaft when not in operation, so as to prevent excessive wear, thereby effectively enhancing the practical effect of the present disclosure.
3) The connection position between the stirring blades and the stirring shaft during ultrasonic vibration transmission is prone to significant stress concentration, leading to obvious mechanical damage. To solve this problem, an isolation sleeve is additionally arranged and is connected to the buffer rubber gasket between the installation holes of the isolation sleeve and the mounting parts of the stirring blades, thereby improving the support effect on the stirring blades, dispersing the force at the connection position between the stirring blades and the stirring shaft, and significantly reducing the mechanical damage at the connection position between the stirring blades and the stirring shaft, and the support is a buffer support, so the support will not have an excessive impact on the transmission of ultrasonic vibration, further enhancing the practical effect of the present disclosure.
4) The bottom end of the connecting rod of the present disclosure is fixedly connected to a vibration isolation mechanism downwards, and the ultrasonic transducer is fixedly connected to the vibration isolation mechanism. By the friction energy dissipation between damping particles inside the vibration damping container of the vibration isolation mechanism, sufficient vibration isolation effect can be formed to prevent excessive transmission of ultrasonic vibration to the driving cylinder through the connecting rod, thereby preventing the impact on the piston airtightness of the cylinder and further ensuring the smooth implementation of the ultrasonic dispersion technology solution of the present disclosure.
5) The electrothermal film precursor solution prepared by the present disclosure was sprayed onto a glass-ceramic plate using conventional spraying methods to form an electrothermal film. After testing, the sheet resistance of the electrothermal film was 162Ω/□, the infrared radiation rate was 83%, and the steady-state heating temperature at 220V was 338° C., while the panel temperature difference was only 19° C. It is obvious that the electrothermal film precursor solution prepared by the present disclosure has excellent performance.

### BRIEF DESCRIPTION OF THE DRAWINGS

FIG. 1 is a structural schematic diagram of the present disclosure.

FIG. 2 is a structural schematic diagram of the reflux condensation mechanism of the present disclosure.

FIG. 3 is a structural schematic diagram of the multifunctional stirring mechanism of the present disclosure.

FIG. 4 is an enlarged view of the portion A in FIG. 3.

FIG. 5 is a structural schematic diagram of the vibration isolation mechanism of the present disclosure.

Reference numbers in the drawings: 1—reaction kettle body, 2—cover, 3—feeding port, 4—cover plate, 5—discharge valve, 6—discharge pipe, 7—reflux condensation mechanism, 701—condensate tank, 702—condensing coil, 703—coil driving motor, 8—rotary joint, 9—condensate inlet pipe, 10—condensate outlet pipe, 11—intake pipe, 12—reflux pipe, 13—multifunctional stirring mechanism, 1301—stirring shaft, 1302—stirring blade, 13021—stirring part, 13022—mounting part, 1303—isolation sleeve, 1304—stirring driving motor, 14—buffer rubber gasket, 15—blind hole, 16—ultrasonic transducer, 17—connecting rod, 18—driving cylinder, 19—external ultrasonic generator, 20—heating jacket, 21—heating liquid inlet pipe, 22—heating liquid outlet pipe, 23—bracket, 24—vibration isolation mechanism, 2401—vibration damping container, 2402—damping particles, 25—conduit.

### DETAILED DESCRIPTION OF THE EMBODIMENTS

For the convenience of those skilled in the art to understand, the embodiments will now be further described in detail with reference to the accompanying drawings regarding the structure of the present disclosure:

### Embodiment 1

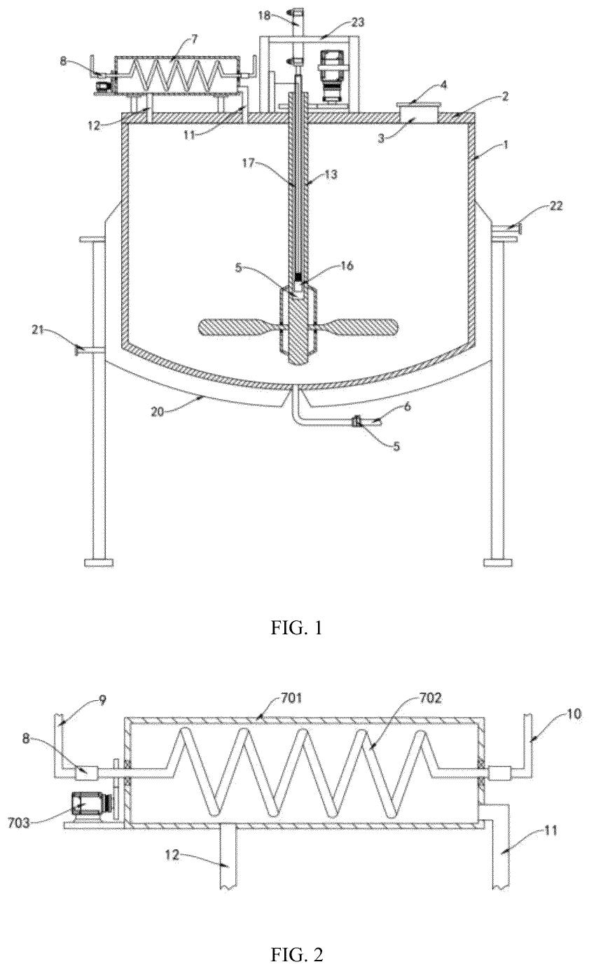

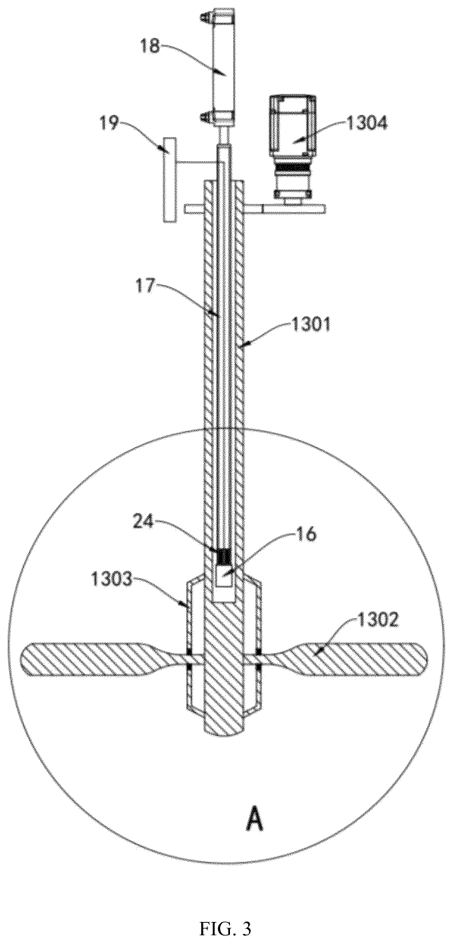

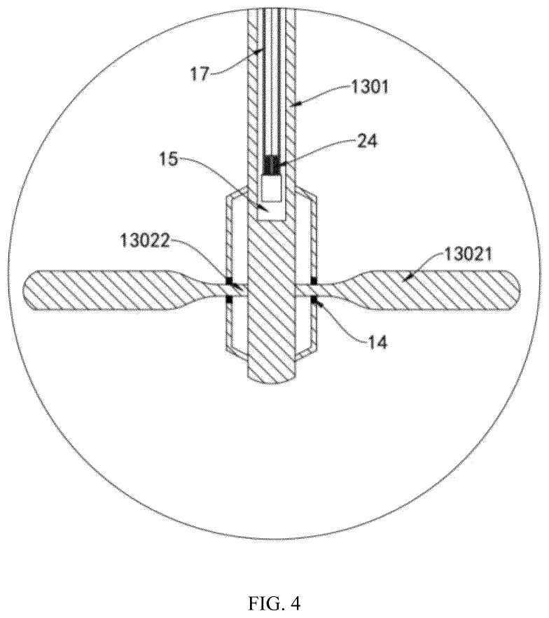

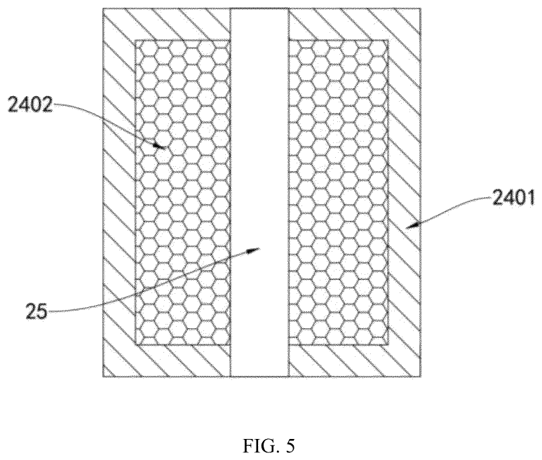

Referring to FIG. 1 to FIG. 5, a mixed reactor includes reaction kettle body 1, a reflux condensation mechanism 7, and a multifunctional stirring mechanism 13.

The top of the reaction kettle body 1 is hermetically and fixedly connected to a corresponding cover 2. One side of the cover 2 is provided with a feeding port 3, and a corresponding cover plate 4 capable of opening and closing is arranged at the feeding port 3. A discharge pipe 6 provided with a discharge valve 5 is arranged on the bottom side of the reaction kettle body 1;

The reflux condensation mechanism 7 includes a condensate tank 701 located on the side of the cover 2 without the feeding port 3. A corresponding condensing coil 702 is wound around the inside of the condensate tank 701, the two ends of the condensing coil 702 are horizontally arranged, and hermetically and rotatably installed on both sides of the condensate tank 701. The two ends of the condensing coil 702 are respectively connected to a condensate inlet pipe 9 and a condensate outlet pipe 10 through corresponding rotary joints 8. One end of the condensate tank 701 is fixedly provided with a coil driving motor 703 for driving the condensing coil 702 to rotate. The cover 2 is provided with an intake pipe 11 for sending evaporated gas into the condensate tank 701, and a reflux pipe 12 for refluxing the condensed liquid into the reaction kettle body 1;

The multifunctional stirring mechanism 13 includes a stirring shaft 1301 rotatably installed in the middle of the cover 2, and a plurality of stirring blades 1302 driven by the stirring shaft 1301. The bottom of the stirring shaft 1301 extends to the inner bottom side of the reaction kettle body 1 and is fixedly sleeved with a corresponding isolation sleeve 1303. The isolation sleeve 1303 is provided with a plurality of installation holes corresponding to the stirring blades 1302 at equal angles. Each stirring blade 1302 includes a stirring part 13021 arranged in a plate shape, and a mounting part 13022 arranged in a shaft shape and fixedly connected to the inside of the stirring part 13021. The mounting parts 13022 penetrate the installation holes of the isolation sleeve 1303 and are fixedly connected to the stirring shaft 1301. The mounting parts 13022 of the stirring blades 1302 are arranged apart from the installation holes, and corresponding buffer rubber gaskets 14 are hermetically connected between the mounting parts 13022 of the stirring blades 1302 and the installation holes respectively. The stirring shaft 1301 on the upper side of the stirring blades 1302 is hollow and is provided with a corresponding blind hole 15. An ultrasonic transducer 16 arranged apart from the blind hole 15 is movably arranged in the blind hole 15. The ultrasonic transducer 16 is connected to the piston rod end of the driving cylinder 18 fixedly installed on the cover 2 through a corresponding connecting rod 17, and the ultrasonic transducer 16 is electrically connected to the external ultrasonic generator 19. When the material is dispersed, the external ultrasonic generator 19 is started, and the ultrasonic transducer 16 is driven by the driving cylinder 18 to descend and abut against the stirring shaft 1301. The stirring shaft 1301 is driven by a stirring driving motor 1304 fixedly installed on the cover 2.

| A corresponding heating jacket 20 is hermetically arranged on the outer side of the reaction kettle body 1 in an interlayer manner. The lower part of the heating jacket 20 is externally connected to a heating liquid inlet pipe 21, and the upper end of the heating jacket 20 is externally connected to a heating liquid outlet pipe 22.

The two ends of the condensing coil 702 are horizontally arranged, and hermetically and rotatably installed on both sides of the condensate tank 701 through corresponding sealing bearings. One end of the condensing coil 702 is connected to the output shaft end of the coil driving motor 703 through gear engagement in a transmission manner.

The buffer rubber gaskets 14 are hermetically connected to the mounting parts 13022 of the stirring blades 1302 and the installation holes of the isolation sleeve 1303 through adhesive bonding.

The top of the stirring shaft 1301 is connected to the output shaft end of the stirring driving motor 1304 through gear engagement in a transmission manner.

The middle of the cover 2 is fixedly connected to a corresponding bracket 23 upwards, and the cylinder body of the driving cylinder 18 is fixedly connected to the bracket 23.

The connecting rod 17 is of a hollow tubular structure, and the bottom end of the connecting rod 17 is fixedly connected to a corresponding vibration isolation mechanism 24 downwards. The ultrasonic transducer 16 is fixedly connected to the vibration isolation mechanism 24.

The vibration isolation mechanism 24 includes a vibration damping container 2401 fixed to the bottom end of the connecting rod 17. The vibration damping container 2401 is filled with a plurality of corresponding damping particles 2402 for vibration damping, and the damping particles 2402 for vibration damping are iron-based spherical particles.

A corresponding conduit 25 is longitudinally penetrates between the upper end and lower end of the vibration damping container 2401, and a threading hole connected to the hollow part of the connecting rod 17 is arranged on the upper side of the connecting rod 17. The conducting wire of the ultrasonic transducer 16 for connecting passes through the conduit 25, the hollow part of the connecting rod 17, and the threading hole, and is then connected to the external ultrasonic generator 19.

### Embodiment 2

A method for preparing electrothermal film precursor solution based on the mixed reactor described in the embodiment 1, including the following steps:
S0, Adding 140 kg of stannic chloride pentahydrate powder to 700 kg of anhydrous ethanol, heating for 35 minutes, and stirring evenly to obtain a tin-containing solution;
Adding 1 kg of antimony trichloride and 2 kg of bismuth trichloride to 15 kg of anhydrous ethanol, heating for 35 minutes, and stirring evenly to obtain a doped solution;
Adding 3 kg of nickel chloride hexahydrate, 4 kg of manganese chloride tetrahydrate, 2 kg of ferric chloride hexahydrate, 2 kg of cuprous chloride, and 1 kg of zinc acetate to 60 kg of anhydrous ethanol, heating for 45 minutes, and stirring evenly to obtain a modifier;
Adding 10 kg of modified carbon nanotubes, 20 kg of 40% silica sol, 2 kg of citric acid, 5 kg of hydrochloric acid, and 5 kg of acetic acid to 200 kg of anhydrous ethanol, heating for 45 minutes, stirring evenly, and dispersing by ultrasound for 15 minutes to obtain a stabilizer;
The diameter of the modified carbon nanotubes is 10-30 nm, and the carbon nanotube modification is prepared by mixed acid ultrasonic hot leaching, deionized water rinsing, and vacuum drying. The diameter of the solute particles in the 40% silica sol is 20-25 nm;
S1, Adding the tin-containing solution into the reaction kettle body 1, adding the doped solution and the modifier to the tin-containing solution, adding methanol and isopropanol as cosolvents, and stirring and mixing the materials for 38 minutes at 70-80° C. with the multifunctional stirring mechanism 13 to obtain a doped tin-containing solution;
During the heating and stirring process, the evaporated gas enters the condensate tank 701 through the intake pipe 11 and flows back into the reaction kettle body 1 after condensing into a liquid;
S2, After the multifunctional stirring mechanism 13 is stopped, adding the stabilizer to the doped tin-containing solution, heating for 120 minutes at 65-75° C. The piston rod of the driving cylinder 18 extends to drive the ultrasonic transducer 16 to abut against the bottom side of the blind hole 15 of the stirring shaft 1301, and start the external ultrasonic generator 19 and the multifunctional stirring mechanism 13. The ultrasonic vibration formed by the ultrasonic transducer 16 is transmitted to the stirring blades 1302 during the rotation process through the stirring shaft 1301, and uniformly acts on the material to ultrasonically disperse for 15 minutes;
S3, Stopping the multifunctional stirring mechanism 13, and thermal aging the material at 30° C. for 30 hours to obtain an electrothermal film precursor solution;
S4, Draining the electrothermal film precursor solution into the corresponding storage tank for storage.

### Embodiment 3

A spraying film-forming process for electrothermal film including the following steps:
S1, Substrate cleaning: taking glass-ceramic plate as an example, washing the glass-ceramic plate with a low concentration of hydrochloric acid solution and deionized water, drying and cleaning the glass-ceramic plate with a plasma cleaner for later use;
S2, Ultrasonic homogenization of precursor solution: performing a homogenizing treatment on the electrothermal film precursor solution described in the embodiment 2 with an ultrasonic disperser for 10 minutes;
S3, Substrate preheating: heating the glass-ceramic plate to 600-700° C.;
S4, Spraying films: filling the electrothermal film precursor solution described in the embodiment 2 into the liquid reservoir of the ultrasonic spraying equipment, and spraying the atomizing the electrothermal film precursor solution on the surface of the preheated glass-ceramic plate repeatedly;
S5, Annealing and shaping: sending the glass-ceramic plate coated with films into an annealing furnace and annealing at 450-600° C. for 12 minutes;

After testing, the performance of the electrothermal film prepared in embodiment 3 of the present disclosure is shown in Table 1.

Performance testing results data table for the electrothermal film:

TABLE 1

| sheet | | steady-state heating | |
|---|---|---|---|
| resistance | infrared | temperature at | panel temperature |
| (Ω/□) | radiance % | 220 V (° C.) | difference (° C.) |
| 162 | 83 | 338 | 19 |

According to Table 1, the sheet resistance of the electrothermal film prepared in embodiment 3 of the present disclosure is 162Ω/□, the infrared radiation rate is 83%, and the steady-state heating temperature at 220V is 338° C., while the panel temperature difference is only 19° C. It is obvious that the precursor solution of the electrothermal film prepared in the present disclosure has excellent performance.

The above is only the preferred embodiment of the present disclosure. It should be noted that for the ordinary person skilled in the art, several improvements and modification can be made without departing from the principles of the present disclosure, and these improvements and modification should also be considered as the scope of the present disclosure.

1. A mixed reactor, comprising a reaction kettle body, a reflux condensation mechanism, and a multifunctional stirring mechanism;
wherein a top of the reaction kettle body is hermetically and fixedly connected to a corresponding cover, one side of the cover is provided with a feeding port, a corresponding cover plate capable of opening and closing is arranged at the feeding port, a discharge pipe provided with a discharge valve is arranged on a bottom side of the reaction kettle body;
the reflux condensation mechanism comprises a condensate tank located on the side of the cover without the feeding port, a corresponding condensing coil is wound around inside of the condensate tank, two ends of the condensing coil are horizontally arranged, and hermetically and rotatably installed on both sides of the condensate tank, the two ends of the condensing coil are respectively connected to a condensate inlet pipe and a condensate outlet pipe through corresponding rotary joints, one end of the condensate tank is fixedly provided with a coil driving motor for driving the condensing coil to rotate, the cover is provided with an intake pipe for sending evaporated gas into the condensate tank, and a reflux pipe for refluxing the condensed liquid into the reaction kettle body;
the multifunctional stirring mechanism comprises a stirring shaft rotatably installed in a middle of the cover, and a plurality of stirring blades driven by the stirring shaft; a bottom of the stirring shaft extends to an inner bottom side of the reaction kettle body and is fixedly sleeved with a corresponding isolation sleeve, the isolation sleeve is provided with a plurality of installation holes corresponding to the stirring blades at equal angles; each stirring blade comprises a stirring part arranged in a plate shape, and a mounting part arranged in a shaft shape and fixedly connected to an inside of the stirring part, a plurality of the mounting parts penetrate the installation holes of the isolation sleeve and are fixedly connected to the stirring shaft, the mounting parts of the stirring blades are arranged apart from the installation holes, corresponding buffer rubber gaskets are hermetically connected between the mounting parts of the stirring blades and the installation holes respectively, the stirring shaft on the upper side of the stirring blades is hollow and is provided with a corresponding blind hole, an ultrasonic transducer arranged apart from the blind hole is movably arranged in the blind hole, the ultrasonic transducer is connected to a piston rod end of a driving cylinder fixedly installed on the cover through a corresponding connecting rod, the ultrasonic transducer is electrically connected to the external ultrasonic generator, and the stirring shaft is driven by a stirring driving motor fixedly installed on the cover;
the connecting rod is of a hollow tubular structure, a bottom end of the connecting rod is fixedly connected to a corresponding vibration isolation mechanism downwards, and the ultrasonic transducer is fixedly connected to the vibration isolation mechanism;
the vibration isolation mechanism comprises a vibration damping container fixed to the bottom end of the connecting rod, the vibration damping container is filled with a plurality of corresponding damping particles for vibration damping, and the damping particles for vibration damping are iron-based spherical particles.

2. The mixed reactor according to claim 1, wherein a corresponding heating jacket is hermetically arranged on an outer side of the reaction kettle body in an interlayer manner, a lower part of the heating jacket is externally connected to a heating liquid inlet pipe, and an upper end of the heating jacket is externally connected to a heating liquid outlet pipe.

3. The mixed reactor according to claim 1, wherein the two ends of the condensing coil are horizontally arranged, and hermetically and rotatably installed on both sides of the condensate tank through corresponding sealing bearings, and one end of the condensing coil is connected to an output shaft end of the coil driving motor through gear engagement in a transmission manner.

4. The mixed reactor according to claim 1, wherein the buffer rubber gaskets are hermetically connected to the mounting parts of the stirring blades and the installation holes of the isolation sleeve through adhesive bonding.

5. The mixed reactor according to claim 1, wherein a top of the stirring shaft is connected to an output shaft end of the stirring driving motor through gear engagement in a transmission manner.

6. The mixed reactor according to claim 1, wherein the middle of the cover is fixedly connected to a corresponding bracket upwards, and a cylinder body of the driving cylinder is fixedly connected to the bracket.

7-8. (canceled)

9. The mixed reactor according to claim 1, wherein a corresponding conduit is longitudinally penetrates between an upper end and a lower end of the vibration damping container, a threading hole connected to a hollow part of the connecting rod is arranged on an upper side of the connecting rod, a conducting wire of the ultrasonic transducer for connecting passes through the conduit, the hollow part of the connecting rod, and the threading hole, and is then connected to the external ultrasonic generator.

10. A method for preparing electrothermal film precursor solution based on the mixed reactor according to claim 2, comprising the following steps:
S1, adding a tin-containing solution into the reaction kettle body, adding a doped solution and a modifier to the tin-containing solution, adding methanol and isopropanol as cosolvents, and stirring and mixing materials for 30-45 minutes at 70-80° C. with the multifunctional stirring mechanism to obtain a doped tin-containing solution;
during heating and stirring process, the evaporated gas enters the condensate tank through the intake pipe and flows back into the reaction kettle body after condensing into liquid;
wherein the doped solution is formed by uniformly mixing antimony trichloride, bismuth chloride, and anhydrous ethanol; the modifier is formed by uniformly mixing nickel chloride hexahydrate, manganese chloride tetrahydrate, ferric chloride hexahydrate, cuprous chloride, zinc acetate, and anhydrous ethanol; and the tin-containing solution is formed by mixing stannic chloride pentahydrate powder with anhydrous ethanol;
S2, after the multifunctional stirring mechanism is stopped, adding a stabilizer to the doped tin-containing solution, heating for 120 minutes at 65-75° C., the piston rod of the driving cylinder extends to drive the ultrasonic transducer to abut against a bottom side of the blind hole of the stirring shaft, and starting the external ultrasonic generator and the multifunctional stirring mechanism, transmitting the ultrasonic vibration formed by the ultrasonic transducer to the stirring blades during a rotation process through the stirring shaft to uniformly act on materials to ultrasonically disperse for 15 minutes;
wherein the stabilizer is formed by uniformly mixing modified carbon nanotubes, 40% silica sol, citric acid, hydrochloric acid, acetic acid and anhydrous ethanol, a diameter of the modified carbon nanotubes is 10-30 nm, the carbon nanotube modification is prepared by mixed acid ultrasonic hot leaching, deionized water rinsing, and vacuum drying, and a diameter of the solute particles in the 40% silica sol is 20-25 nm;
S3, stopping the multifunctional stirring mechanism, and thermal aging the materials at 30° C. for 24-36 hours to obtain the electrothermal film precursor solution;
S4, draining the electrothermal film precursor solution into corresponding storage tank for storage.
